(19) United States
(12) Patent Application Publication
(10) Pub. No.: US 2005/0246403 A1
(43) Pub. Date: Nov. 3, 2005

(54) Interpolation method and apparatus performing the same

(75) Inventor: De-Wei Lee, Kaohsiung City (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/110,163

(22) Filed: Apr. 20, 2005

(30) Foreign Application Priority Data
Apr. 20, 2004 (TW) 93110972

(51) Int. Cl. G06F 7/38

(52) U.S. Cl. 708/290

(57) ABSTRACT

An interpolation method and an apparatus are provided for determining an m-th interpolated value, Vₘ, between a lower boundary, LB, and an upper boundary, UB, with N interpolated intervals. The method includes the following steps (a) calculating a difference value, D, between LB and UB; (b) selecting an integer, Int, wherein (N times Int) is not larger than D and (N times (Int+1)) is larger than D, and taking Int as a whole part of value of each interpolated interval; (c) calculating a remainder value, R, as difference between D and (N times Int); (d) selecting an index value, Ix, based on R, and taking Ix as a tenth digit of value of each interpolated interval; and (e) selecting a carry number, Kₘ, and an adjustment number, Rₘ, based on Ix, and (f) generating Vₘ based on Int, Kₘ, and Rₘ.

### CROSS-REFERENCE TO RELATED APPLICATIONS

This application claims the right of priority based on Taiwan Patent Application No. 093110972 entitled “Interpolation Method and Apparatus of The Same,” filed on Apr. 20, 2004, which is incorporated herein by reference and assigned to the assignee herein.

### FIELD OF INVENTION

The present invention relates to an interpolation method and an interpolation device.

### BACKGROUND OF THE INVENTION

For digital signal processing, sometimes it is required to perform interpolation between two values, for example, to interpolate (N−1) interpolated values between a lower boundary, LB, and an upper boundary, UB. FIG. 1 shows a device for interpolation of the prior art. A substractor 101 acquires LB and UB to generate a difference, D. Because (N−1) interpolated values come with N interpolated intervals, a divider 103 divides D by N to obtain each interpolated interval, I. Starting from LB, an adder 105 recursively adds each interpolated interval to obtain each interpolated value, Vₘ.

However, the divider 103 shown in FIG. 1 usually occupies a larger IC arrangement area and thus works inefficiently. As a result, an interpolation method and an interpolation device with a smaller IC size and the higher performance are demanded.

### SUMMARY OF THE INVENTION

It is an aspect of the present invention to provide an interpolation method and an interpolation device with a smaller IC size and the higher performance.

The interpolation method is operated by a digital signal generator for determining an m-th interpolated value, Vₘ, between a lower boundary, LB, and an upper boundary, UB, with N interpolated intervals. N and m are integers. The method includes: (a) calculating a difference value, D, between LB and UB; (b) selecting an integer, Int, wherein (N times Int) is not larger than D and (N times (Int+1)) is larger than D, and taking Int as a whole part of value of each interpolated interval; (c) calculating a remainder value, R, as difference between D and (N times Int); (d) selecting an index value, Ix, based on R, wherein Ix is selectively equal to any integer from 1 to 9, and taking Ix as a tenth digit of value of each interpolated interval; and (e) selecting a carry number, Kₘ, and an adjustment number, Rₘ, based on Ix, and (f) generating Vₘ based on Int, Kₘ, and Rₘ, wherein Kₘ is equal to 0 or 1 indicating whether Vₘ should be carried, and Rₘ is used for adjusting a sum of Int and K_{m,}.

In one embodiment, the step (d) includes: (d1) establishing a reference table of a plurality of field values, Tᵣ(X, Y), wherein X denotes the column of Tᵣ(X, Y), Y denotes the row of Tᵣ(X, Y), and each field value of Tᵣ(X, Y) is determined as the tenth digit of (Y/(X+1)). The step (e) includes: (e1) establishing a carry table of a plurality of field values, T_{c}(A, B), wherein A denotes the column of T_{c}(A, B), B denotes the row of T_{c}(A, B), and each field value of T_{c}(A, B) is determined based on (B times A); and (e2) establishing an (N−1)th adjustment table of a plurality of field values, T_{a, N-1}(A, B), wherein A denotes the column of T_{a, N-1}(A, B), B denotes the row of T_{a, N-1}(A, B), and each field value of T_{a, N-1}(A, B) is determined based on Int and the field values of T_{c}(A, B).

In this embodiment, the step (d) further includes: (d2) looking up a field value, Tᵣ((N−1), R), in Tᵣ(X, Y) to obtain Ix. The step (e) further includes: (e3) repeating the following steps from m being set as 1 until m being larger than (N−1). The step (e3) includes: (e4) looking up a field value, T_{c}(Ix, m), in T_{c}(A, B) to obtain Kₘ; and (e5) looking up a field value, T_{a, N-1}(Ix, m), in T_{a, N-1}(A, B) to obtain Rₘ. The step (f) further includes (f1) determining Vₘ as a sum of LB, Int, Kₘ, and Rₘ when m is set as 1, otherwise determining Vₘ as a sum of Vₘ₋₁, Int, Kₘ, and (Rₘ minus Rₘ₋₁).

It should be noted that the description herein is not intended to limit the order of performing the step of establishing Tᵣ(X, Y), the step of establishing T_{c}(A, B), and the step of establishing T_{a, N-1}(A, B). These steps can be performed in any order as long as they are performed before the step of looking up Tᵣ((N−-1), R), the step of looking up T_{c}(Ix, m), and the step of looking up T_{a, N-1}(IX, m). For example, they can be performed in the order of establishing Tᵣ(X, Y) and then looking up Tᵣ((N−1), R), establishing T_{c}(A, B) and then looking up T_{c}(Ix, m), and establishing T_{a, N-1}(A, B) and then looking up T_{a, N-1}(IX, m). In another embodiment, the step of establishing Tᵣ(X, Y), the step of establishing T_{c}(A, B), and the step of establishing T_{a, N-1}(A, B) are performed prior to the step of calculating a difference value, D, between LB and UB.

The interpolation device is operated by a digital signal generator for determining an m-th interpolated value, Vₘ, between a lower boundary, LB, and an upper boundary, UB, with N interpolated intervals. N and m are integers. The interpolation device includes a first calculating device, a first selecting device, a second calculating device, a second selecting device, a third selecting device, and a generator. The first calculating device calculates a difference value, D, between LB and UB. The first selecting device selects an integer, Int, wherein (N times Int) is not larger than D and (N times (Int+1)) is larger than D, and takes Int as a whole part of value of each interpolated interval. The second calculating device calculates a remainder value, R, as difference between D and (N times Int). The second selecting device selects an index value, Ix, based on R, wherein Ix is selectively equal to any integer from 1 to 9, and takes Ix as a tenth digit of value of each interpolated interval. The third selecting device selects a carry number, Kₘ, and an adjustment number, Rₘ, based on Ix, wherein kₘ is equal to 0 or 1 indicating whether Vₘ should be carried, Rₘ is used for adjusting a sum of Int and Kₘ. The generator generates Vₘ based on Int, Kₘ, and Rₘ.

In one embodiment, the second selecting device includes a first determining unit, and the third selecting device includes a second determining unit and a third determining unit. The first determining unit establishes a reference table of a plurality of field values, Tᵣ(X, Y), wherein X denotes the column of Tᵣ(X, Y), Y denotes the row of Tᵣ(X, Y), and each field value of Tᵣ(X, Y) is determined as the tenth digit of (Y/(X+1)). The second determining unit establishes a carry table of a plurality of field values, T_{c}(A, B), wherein A denotes the column of T_{c}(A, B), B denotes the row of T_{c}(A, B), and each field value of T_{c}(A, B) is determined based on (B times A). The third determining unit establishes a plurality of adjustment tables including an (N−1)th adjustment table of a plurality of field values, T_{a, N-1}(A, B), wherein A denotes the column of T_{a, N-1}(A, B), B denotes the row of T_{a, N-1}(A, B), and each field value of T_{a, N-1}(A, B) is determined based on Int and the field values of T_{c}(A, B).

In this embodiment, the second selecting device further includes a first lookup unit, and the third selecting device includes a second lookup unit and a third lookup unit. The first lookup unit looks up a field value, Tᵣ((N−1), R), in Tᵣ(X, Y) to obtain Ix. The second lookup unit looks up a field value, T_{c}(Ix, m), in T_{c}(A, B) to obtain K_{m.} The third lookup unit looks up a field value, T_{a, N-1}(IX, m), in T_{a, N-1}(A, B) to obtain Rₘ.

In other embodiments, the interpolation device further includes a logic unit for directing the second selecting device, the third selecting device, and the generator to repeat generating Vₘ from m being set as 1 until m being larger than (N−1). The generator further includes a summation unit for determining Vₘ as a sum of LB, Int, Kₘ, and Rₘ when m is set as 1, otherwise determining Vₘ as a sum of Vₘ₋₁, Int, Kₘ, and (Rₘ minus Rₘ₋₁).

### BRIEF DESCRIPTION OF THE DRAWINGS

The present invention is described in further detail in the following, with reference to the accompanying drawings in which:

FIG. 1 is a block diagram of an interpolation device according to a prior art;

FIG. 2 is a flow chart according to an embodiment of the present invention;

FIG. 3 is block diagram according to an embodiment of the present invention;

FIG. 4 illustrates the first selecting device 304 according to FIG. 3;

FIG. 5 is a reference table according to an embodiment of the present invention;

FIG. 6 is a carry table according to an embodiment of the present invention; and

FIG. 7 is an adjustment table according to an embodiment of the present invention.

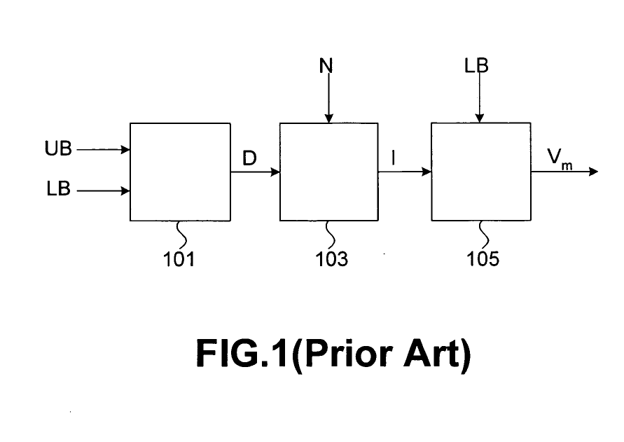

### DETAILED DESCRIPTION

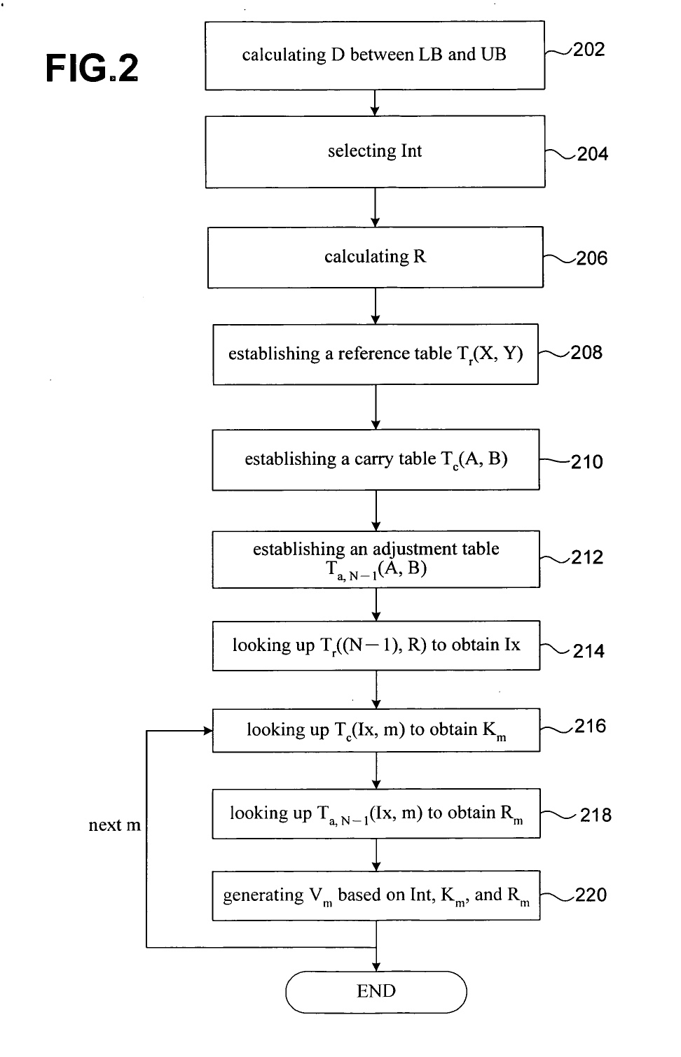

FIG. 2 is a flow chart of an embodiment of the present invention. In this embodiment, between a lower boundary, LB, and an upper boundary, UB, an m-th interpolated value, Vₘ, is determined with N interpolated intervals. N and m are integers; N is larger than 1.

The method shown in FIG. 2 begins with the step 202: inputting LB and UB and calculating a difference value, D, between LB and UB. In an embodiment, LB and UB are carried by at least one signal, wherein LB and UB are integers representing respectively a voltage level or a pulse number. In the step 204:

selecting an integer, Int, so that (N times Int) is not larger than D and (N times (Int+1)) is larger than D, and taking Int as a whole part of value of each interpolated interval. In the step 206: calculating a remainder value, R, as a difference between D and (N times Int).

Then it moves to the step 208: establishing a reference table of a plurality of field values, Tᵣ(X, Y), wherein X denotes the column of Tᵣ(X, Y), Y denotes the row of Tᵣ(X, Y), and each field value of Tᵣ(X, Y) is determined as the tenth digit of (Y/(X+1)). In the step 210: establishing a carry table of a plurality of field values, T_{c}(A, B), wherein A denotes the column of T_{c}(A, B), B denotes the row of T_{c}(A, B), and each field value of T_{c}(A, B) is determined based on (B times A). In the step 212: establishing an (N−1)th adjustment table of a plurality of field values, T_{a, N-1}(A, B), wherein A denotes the column of T_{a, N-1} (A, B), B denotes the row of T_{a, N-1}(A, B), and each field value of T_{a, N-1}(A, B) is determined based on Int and the field values of T_{c}(A, B).

Next, in the step 214: looking up a field value, Tᵣ((N−1), R), in Tᵣ(X, Y) to obtain an index value, Ix. Ix is selectively equal to any integer from 1 to 9 and taken as a tenth digit of value of each interpolated interval. In the step 216: looking up a field value, T_{c}(Ix, m), in T_{c}(A, B) to obtain a carry number, Kₘ. kₘ is equal to 0 or 1, indicating whether Vₘ should be carried. That is, kₘ indicates whether Vₘ should be rounded up or rounded down to the first digit of value of each interpolated interval. In the step 218: looking up a field value, T_{a, N-1}(Ix, m), in T_{a, N-1}(A, B) to obtain Rₘ. Rₘ is used for adjusting a sum of Int and Kₘ. In the step 220: generating Vₘ based on Int, Kₘ, and Rₘ, when m is set as 1, Vₘ is determined as a sum of LB, Int, Kₘ, and Rₘ, otherwise Vₘ is determined as a sum of Vₘ₋₁, Int, Kₘ, and (Rₘ minus Rₘ₋₁). In another embodiment, the steps 216, 218, and 220 recur to generate Vₘ from m being set as 1 until m being larger than (N−1).

The illustrate order of steps 208, 210, and 212 are not intended to limit the order of carrying out the present invention. These steps can be performed in any order as long as they are performed before the steps 214, 216, and 218. For example, they can be performed in an order of the step 214 immediately following the step 208, the step 216 immediately following the step 210, and step 218 immediately following the step 210. In another example, the steps 208, 210, and 212 are performed prior to the step 202 of calculating a difference value, D, between LB and UB.

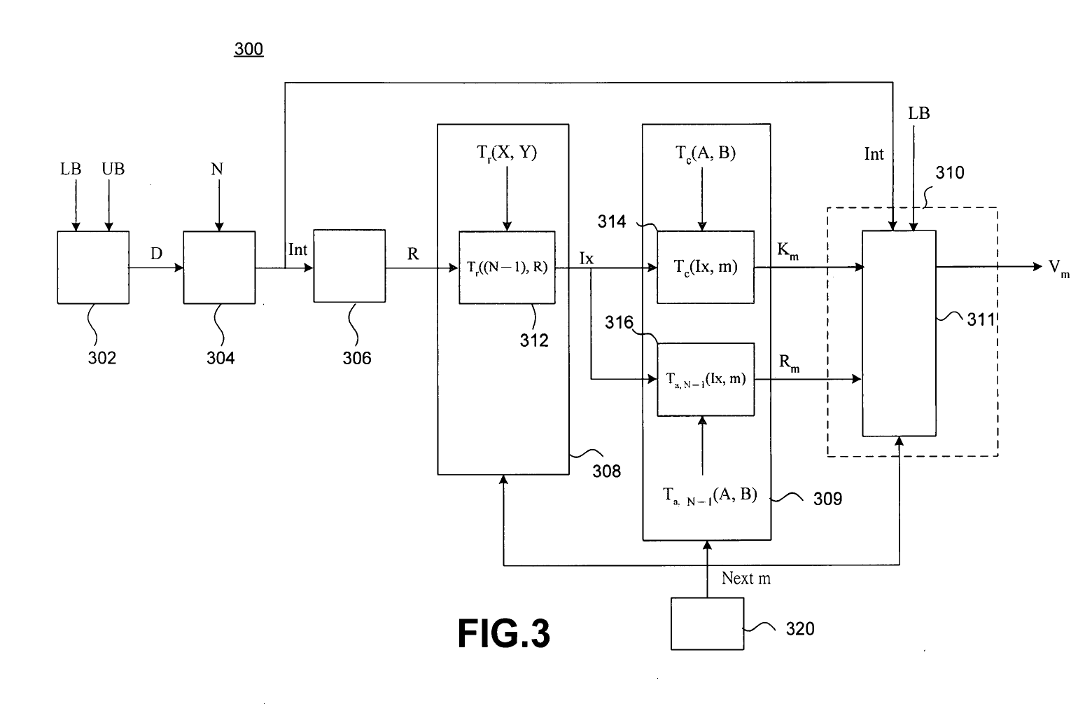

FIG. 3 is a block diagram of an embodiment for the device 300 of the present invention. In this embodiment, an interpolation device 300 determines an m-th interpolated value, Vₘ, between a lower boundary, LB, and an upper boundary, UB, with N interpolated intervals. N and m are integers; N is larger than 1.

The interpolation device 300 includes a first calculating device 302, a first selecting device 304, a second calculating device 306, a second selecting device 308, a third selecting device 309, and a generator 310. The first calculating device 302 receives at least a signal carrying LB and UB and then calculates a difference value, D. In one embodiment, LB and UB are integers representing respectively a voltage level or a pulse number. The first selecting device 304 selects and outputs an integer, Int, so that (N times Int) is not larger than D and (N times (Int+1)) is larger than D, and takes Int as a whole part of value of each interpolated interval. The second calculating device 306 calculates and outputs a remainder value, R, as difference between D and (N times Int). The second selecting device 308 selects an index value, Ix, based on R, wherein Ix is selectively equal to any integer from 1 to 9, and takes Ix as a tenth digit of value of each interpolated interval. The third selecting device 309 selects a carry number, Kₘ, and an adjustment number, Rₘ, based on Ix, wherein kₘ is equal to 0 or 1, indicating whether Vₘ should be carried, Rₘ is used for adjusting a sum of Int and Kₘ. The generator 310 generates Vₘ based on Int, Kₘ, and Rₘ.

In one embodiment, the second selecting device 308 stores a reference table of a plurality of field values, Tᵣ(X, Y), and the third device 309 includes a carry table of a plurality of field values, T_{c}(A, B), and an (N−1)th adjustment table of a plurality of field values, T_{a, N-1}(A, B). In Tᵣ(X, Y), X denotes the column of Tᵣ(X, Y), Y denotes the row of Tᵣ(X, Y), and each field value of Tᵣ(X, Y) is determined as the tenth digit of (Y/(X+1)). In T_{c}(A, B), A denotes the column of T_{c}(A, B), B denotes the row of T_{c}(A, B), and each field value of T_{c}(A, B) is determined based on (B times A). In T_{a, N-1}(A, B), A denotes the column of T_{a, N-1}(A, B), B denotes the row of T_{a, N-1}(A, B), and each field value of T_{a, N-1}(A, B) is determined based on Int and the field values of T_{c}(A, B).

In this embodiment, the second selecting device 308 further includes a first lookup unit 312, and the third selecting device 309 further includes a second lookup unit 314 and a third lookup unit 316. The first lookup unit 312 looks up a field value, Tᵣ((N−1), R), in Tᵣ(X, Y) to obtain Ix. The second lookup unit 314 looks up a field value, T_{c}(Ix, m), in T_{c}(A, B) to obtain Kₘ. When kₘ is equal to 1, Vₘ should be carried. In other words, kₘ indicates whether Vₘ should be rounded up or rounded down to the first digit of value of each interpolated interval. The third lookup unit 316 looks up a field value, T_{a, N-1}(IX, m), in T_{a, N-1}(A, B) to obtain Rₘ.

In another embodiment, the interpolation device 300 further includes a logic unit 320 for directing the second selecting device 308, third selecting device 309, and the generator 310 to recursively generate Vₘ from m being set as 1 until m being larger than (N−1). The generator 310 further includes a summation unit 311 for determining Vₘ as a sum of LB, Int, Kₘ, and Rₘ when m is set as 1, otherwise determining Vₘ as a sum of Vₘ₋₁, Int, Kₘ, and (Rₘ minus Rₘ₋₁).

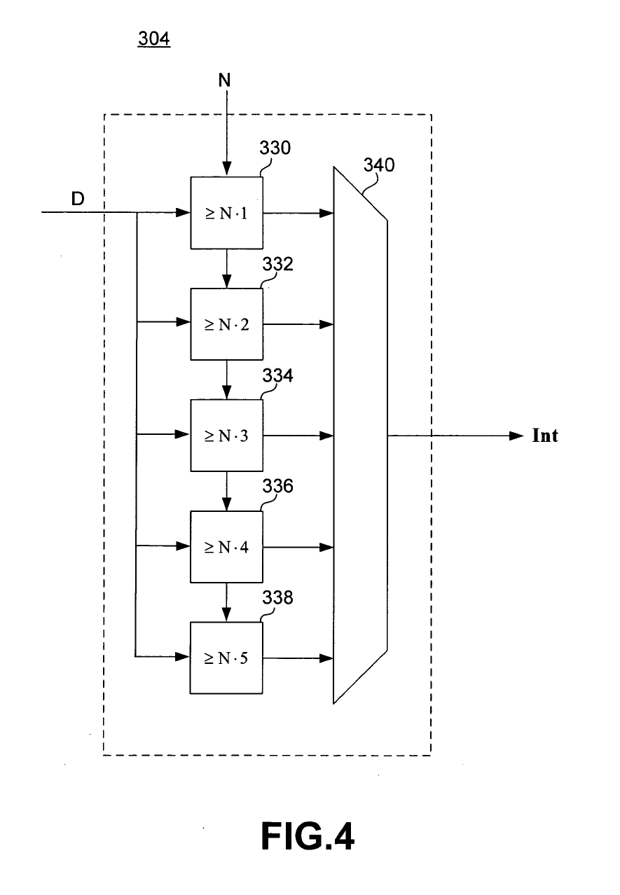

FIG. 4 further illustrates the first selecting device 304. For the exemplary purpose, the possible range of Int is assumed between 0 and 4, that is, Int is selected among five integers. Therefore the first selecting device 304 includes 5 comparators 330-338 for selecting Int. It should be noted that when the possible range of Int is greater, the first selecting device 304, accordingly, includes more comparators. When N and D are inputted into the first selecting device 304, it begins with the comparator 330 to compare N with D. If N is larger than D, the multiplexer 340 outputs 0 as the selected Int. If N is not larger than D, it moves to the comparator 332 to compare 2N with D. In this stage, if 2N is larger than D, the multiplexer 340 outputs 1 as the selected Int. If 2N is not larger than D, it goes to the comparator 334 to compare 3N with D. According to this manner, the first selecting device selects Int.

### EXEMPLARY EMBODIMENT

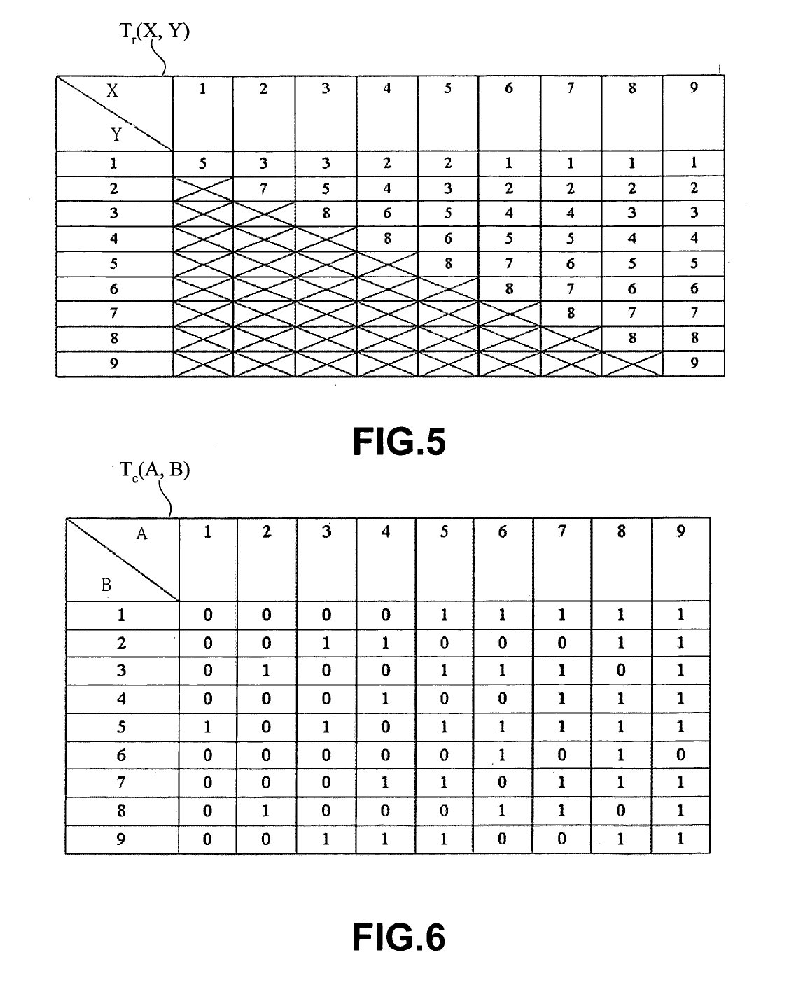

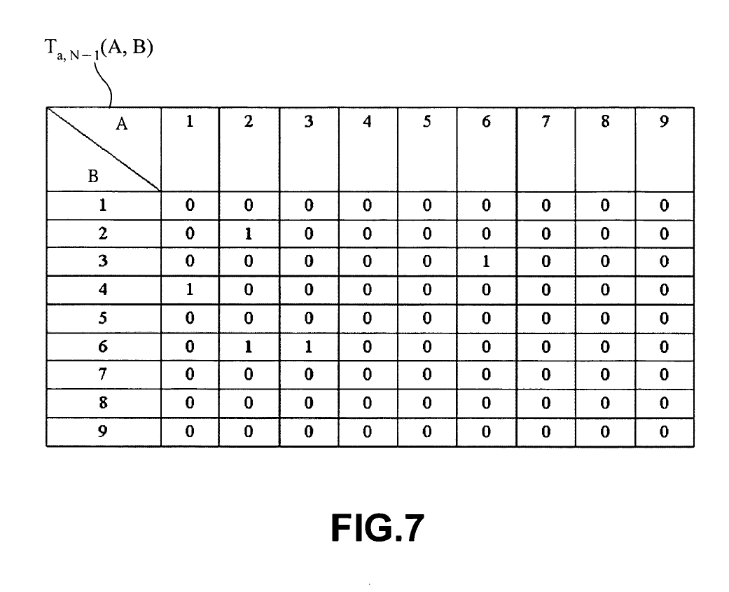

The following example is provided for the purpose of understanding the present invention. It assumes 7 interpolated intervals between 10(LB) and 12(UB). The reference table Tᵣ(X, Y), the carry table T_{c}(A, B), and the (N−1)th adjustment table T_{a, N-1}(A, B) are respectively pre-established in FIG. 5, FIG. 6, and FIG. 7. In FIG. 5, X denotes the column of Tᵣ(X, Y), Y denotes the row of Tᵣ(X, Y), and each field value of Tᵣ(X, Y) is determined as the tenth digit of (Y/(X+1)). In FIG. 6, A denotes the column of T_{c}(A, B), B denotes the row of T_{c}(A, B), and each field value of T_{c}(A, B) is determined based on (B times A). For N being set as 7, FIG. 7 shows the 6th adjustment table, T_{a, 6}(A, B). In FIG. 7, A denotes the column of T_{a, 6}(A, B), B denotes the row of T_{a, 6}(A, B), and each field value of T_{a, 6}(A, B) is determined based on Int and the field values of T_{c}(A, B).

The following are the steps for this embodiment:
calculating a difference value, D, between 10(LB) and 12(UB); obtaining D=2.
selecting an integer, Int, wherein (N×Int)≦D<(N×(Int+1)), that is, 7Int≦2<(7×(Int+1)); obtaining Int=0; taking 0 as a whole part of value of each interpolated interval.
calculating a remainder value, R, as difference between D and (N times Int), wherein R=D−(N×Int)=2−7×0=2; obtaining R=2.
taking N=7 and R=2 to look up Tᵣ((N−1), R), in Tᵣ(X, Y), wherein Tᵣ(6, 2)=2 in FIG. 5; obtaining Ix=2.
taking m=1.
looking up T_{c}(Ix, m), in T_{c}(A, B), wherein T_{c}(2, 1)=0 in FIG. 6; obtaining K₁=0.
looking up T_{a, 6}(Ix, m), in T_{a, 6}(A, B), wherein T_{a, 6}(2, 1)=0 in FIG. 7; obtaining R₁=0.
generating V₁, where V₁=LB+Int+K₁+R₁=10+0+0+0=10; obtaining V₁=10.
taking m=2.
looking up T_{c}(Ix, m), in T_{c}(A, B), wherein T_{c}(2, 2)=0 in FIG. 6; obtaining K₁=0.
looking up T_{a, 6}(Ix, m), in T_{a, 6}(A, B), wherein T_{a, 6}(2, 2)=1 in FIG. 7; obtaining R₂=1.
generating V₂, where V₂=V₁+Int+K₂+R₂−R₁=10+0+0+1−0=11; obtaining V₂=11
taking m=3.
looking up T_{c}(Ix, m), in T_{c}(A, B), wherein T_{c}(2, 3)=1 in FIG. 6; obtaining K₃=1.
looking up T_{a, 6}(Ix, m), in T_{a, 6}(A, B), wherein T_{a, 6}(2, 3)=0 in FIG. 7; obtaining R₃=0.
generating V₃, where V₃=V₂+Int+K₃+R₃−R₂=11+0+1+0−1=11; obtaining V₃=11.
taking m=4.
looking up T_{c}(Ix, m), in T_{c}(A, B), wherein T_{c}(2, 4)=0 in FIG. 6; obtaining K₄=0.
looking up T_{a, 6}(Ix, m), in T_{a, 6}(A, B), wherein T_{a, 6}(2, 4)=0 in FIG. 7; obtaining R₄=0.
generating V₄, where V₄=V₃+Int+K₄+R₄−R₃=11+0+0+0−0=11; obtaining V₄=11.
taking m=5.
looking up T_{c}(Ix, m), in T_{c}(A, B), wherein T_{c}(2, 5)=0 in FIG. 6; obtaining K₅=0.
looking up T_{a, 6}(Ix, m), in T_{a, 6}(A, B), wherein T_{a, 6}(2, 5)=0 in FIG. 7; obtaining R₅=0.
generating V₅, where V₅=V₄+Int+K₅+R₅−R₄=11+0+0+0−0=11; obtaining V₅=11.
taking m=6.
looking up T_{c}(Ix, m), in T_{c}(A, B), wherein T_{c}(2, 6)=0 in FIG. 6; obtaining K₆=0.
looking up T_{a, 6}(Ix, m), in T_{a, 6}(A, B), wherein T_{a, 6}(2, 1)=1 in FIG. 7; obtaining R₆=1.
generating V₆, where V₆=V₅+Int+K₆+R₆−R₅=11+0+0+1−0=12; obtaining V₆=12.
concluding it all together, the six interpolated values are obtained as V₁=10, V₂=11, V₃=11, V₄=11, V₅=11, and V₆=12.

Also disclosed is another embodiment using an appropriately programmed computer system. The computer system includes a host server or other computing systems including a processor for processing digital data, a memory coupled to the processor for storing digital data, an input digitizer coupled to the processor for inputting digital data, an application program stored in the memory and accessible by the processor for directing processing of digital data by the processor. The memory may be also provided for storing the reference table Tᵣ(X, Y), the carry table T_{c}(A, B), and the (N−1)th adjustment table T_{a, N-1}(A, B). The input digitizer is provided for inputting LB, UB, and N. Therefore, the flowchart of FIG. 2 can be implemented by the processor under appropriate process control and instruction from procedures stored in the system memory.

As will be appreciated by one of ordinary skill in the art, the present invention may be embodied as a method, an interpolation device, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

While this invention has been described with reference to the illustrative embodiments, these descriptions should not be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. An interpolation method, operated by a digital signal generator, for determining an m-th interpolated value, Vₘ, between a lower boundary, LB, and an upper boundary, UB, with N interpolated intervals, m and N being integers, said method comprising:
(a) calculating a difference value, D, between LB and UB;
(b) selecting an integer, Int, wherein (N times Int) is not larger than D and (N times (Int+1)) is larger than D, and taking Int as a whole part of value of each interpolated interval;
(c) calculating a remainder value, R, as a difference between D and (N times Int);
(d) selecting an index value, Ix, based on R, and taking Ix as a tenth digit of value of each interpolated interval;
(e) selecting a carry number, Kₘ, and an adjustment number, Rₘ, based on Ix; and
(f) generating Vₘ based on Int, Kₘ, and Rₘ,
wherein kₘ indicates whether Vₘ should be carried, and Rₘ is used for adjusting a sum of Int and Kₘ.

2. The method of claim 1, wherein step (d) comprises:
establishing a reference table of a plurality of field values, Tᵣ(X, Y), wherein X denotes the column of Tᵣ(X, Y), Y denotes the row of Tᵣ(X, Y), and each field value of Tᵣ(X, Y) is determined as the tenth digit of (Y/(X+1)); and
looking up a field value, Tr((N−1), R), in Tᵣ(X, Y) to obtain Ix.

3. The method of claim 2, wherein step (e) comprises:
establishing a carry table of a plurality of field values, T_{c}(A, B), wherein A denotes the column of T_{c}(A, B), B denotes the row of T_{c}(A, B), and each field value of T_{c}(A, B) is determined based on (B times A); and
looking up a field value, T_{c}(Ix, m), in T_{c}(A, B) to obtain Kₘ.

4. The method of claim 3, wherein step (e) comprises:
establishing an (N−1)th adjustment table of a plurality of field values, T_{a, N-1}(A, B), wherein A denotes the column of T_{a, N-1}(A, B), B denotes the row of T_{a, N-1}(A, B), and each field value of T_{a, N-1}(A, B) is determined based on Int and said field values of T_{c}(A, B); and
looking up a field value, T_{a, N-1}(IX, m), in T_{a, N-1}(A, B) to obtain Rₘ.

5. The method of claim 1, wherein step (d) comprises:
(d1) establishing a reference table of a plurality of field values, Tᵣ(X, Y), wherein X denotes the column of Tᵣ(X, Y), Y denotes the row of Tᵣ(X, Y), and each field value of Tᵣ(X, Y) is determined as the tenth digit of (Y/(X+1));
wherein step (e) comprises:
(e1) establishing a carry table of a plurality of field values, T_{c}(A, B), wherein A denotes the column of T_{c}(A, B), B denotes the row of T_{c}(A, B), and each field value of T_{c}(A, B) is determined based on (B times A); and
(e2) establishing an (N−1)th adjustment table of a plurality of field values, T_{a, N-1}(A, B), wherein A denotes the column of T_{a, N-1}(A, B), B denotes the row of T_{a, N-1}(A, B), and each field value of T_{a, N-1}(A, B) is determined based on Int and said field values of T_{c}(A, B).

6. The method of claim 5, wherein step (d) further comprises:
(d2) looking up a field value, Tᵣ((N−1), R), in Tᵣ(X, Y) to obtain Ix;
wherein step (e) further comprises:
(e3) repeating the following steps from m being set as 1 until m being larger than (N−1), said following steps comprising:
(e4) looking up a field value, T_{c}(Ix, m), in T_{c}(A, B) to obtain Kₘ;
(e5) looking up a field value, T_{a, N-1}(IX, m), in T_{a, N-1}(A, B) to obtain Rₘ;
wherein step (f) further comprises:
(f1) determining Vₘ as a sum of LB, Int, Kₘ, and Rₘ when m is set as 1, otherwise determining Vₘ as a sum of Vₘ₋₁, Int, Kₘ, and (Rₘ minus Rₘ₋₁).

7. An interpolation device, operated by a digital signal generator, for determining an m-th interpolated value, Vₘ, between a lower boundary, LB, and an upper boundary, UB, with N interpolated intervals, m and N being integers, said interpolation device comprising:
a first calculating device for calculating a difference value, D, between LB and UB;
a first selecting device for selecting an integer, Int, wherein (N times Int) is not larger than D and (N times (Int+1)) is larger than D, and for taking Int as a whole part of value of each interpolated interval;
a second calculating device for calculating a remainder value, R, as a difference between D and (N times Int);
a second selecting device for selecting an index value, Ix, based on R, and taking Ix as a tenth digit of value of each interpolated interval,
a third selecting device for selecting a carry number, Kₘ, and an adjustment number, Rₘ, based on Ix, and
a generator for generating Vₘ based on Int, Kₘ, and Rₘ;
wherein Kₘ indicates whether Vₘ should be carried, Rₘ is used for adjusting a sum of Int and Kₘ.

8. The interpolation device of claim 7, wherein said second selecting device comprises:
a reference table of a plurality of field values, Tᵣ(X, Y), wherein X denotes the column of Tᵣ(X, Y), Y denotes the row of Tᵣ(X, Y), and each field value of Tᵣ(X, Y) is determined as the tenth digit of (Y/(X+1)); and
a first lookup unit for looking up a field value, Tᵣ((N−1), R), in Tᵣ(X, Y) to obtain Ix.

9. The interpolation device of claim 8, wherein said third selecting device comprises:
a carry table of a plurality of field values, T_{c}(A, B), wherein A denotes the column of T_{c}(A, B), B denotes the row of T_{c}(A, B), and each field value of T_{c}(A, B) is determined based on (B times A); and
a second lookup unit for looking up a field value, T_{c}(Ix, m), in T_{c}(A, B) to obtain Kₘ.

10. The interpolation device of claim 9, wherein said third selecting device comprises:
an (N−1)th adjustment table of a plurality of field values, T_{a, N-1}(A, B), wherein A denotes the column of T_{a, N-1}(A, B), B denotes the row of T_{a, N-1}(A, B), and each field value of T_{a, N-1}(A, B) is determined based on Int and said field values of T_{c}(A, B); and
a third lookup unit for looking up a field value, T_{a, N-1}(IX, m), in T_{a, N-1}(A, B) to obtain Rₘ.

11. The interpolation device of claim 7, wherein said second selecting device comprises:
a reference table of a plurality of field values, Tᵣ(X, Y), wherein X denotes the column of Tᵣ(X, Y), Y denotes the row of Tᵣ(X, Y), and each field value of Tᵣ(X, Y) is determined as the tenth digit of (Y/(X+1));
wherein said third selecting device comprises:
a carry table of a plurality of field values, T_{c}(A, B), wherein A denotes the column of T_{c}(A, B), B denotes the row of T_{c}(A, B), and each field value of T_{c}(A, B) is determined based on (B times A); and
an (N−1)th adjustment table of a plurality of field values, T_{a, N-1}(A, B), wherein A denotes the column of T_{a, N-1}(A, B), B denotes the row of T_{a, N-1}(A, B), and each field value of T_{a, N-1}(A, B) is determined based on Int and said field values of T_{c}(A, B).

12. The interpolation device of claim 11, further comprising:
a logic unit for directing said second selecting device, said third selecting device and said generator to repeat generating Vₘ from m being set as 1 until m being larger than (N−1);
wherein said second selecting device further comprises:
a first lookup unit for looking up a field value, Tᵣ((N−1), R), in Tᵣ(X, Y) to obtain Ix;
wherein said third selecting device comprises:
a second lookup unit for looking up a field value, T_{c}(Ix, m), in T_{c}(A, B) to obtain Kₘ; and
a third lookup unit for looking up a field value, T_{a, N-1}(IX, m), in T_{a, N-1}(A, B) to obtain Rₘ;
wherein said generator comprises:
a summation unit for determining Vₘ as a sum of LB, Int, Kₘ, and Rₘ when m is set as 1, otherwise determining Vₘ as a sum of Vₘ₋₁, Int, Kₘ, and (Rₘ minus Rₘ₋₁).
